(19) United States
(12) Patent Application Publication
(10) Pub. No.: US 2019/0259024 A1
(43) Pub. Date: Aug. 22, 2019

(54) SECURITY ELECTRONIC FILE PROCESSING SYSTEM AND METHOD BASED ON BLOCK CHAIN STRUCTURE

(71) Applicant: CHINA UNIONPAY CO., LTD., Shanghai (CN)

(72) Inventors: Limin ZHANG, Shanghai (CN); Jinzhi HUA, Shanghai (CN); Sishuang WAN, Shanghai (CN); Xu LE, Shanghai (CN)

(73) Assignee: CHINA UNIONPAY CO., LTD., Shanghai (CN)

(21) Appl. No.: 16/333,529

(22) PCT Filed: Sep. 5, 2017
(86) PCT No.: PCT/CN2017/100509

§ 371 Date: Mar. 14, 2019

(30) Foreign Application Priority Data
Sep. 19, 2016 (CN) 201610829326.4

(51) Int. Cl. G06Q 20/36; H04L 9/06; G06Q 20/40

(52) U.S. Cl. CPC G06Q 20/3674; G06Q 20/4014; H04L 9/0637

(57) ABSTRACT

A security electronic file processing method based on a block chain structure is proposed by the present disclosure, including: constructing a security electronic file generation request based on an occurrence of a trigger event by a member node in a block chain formed by a master node and at least one member node, and transmitting the security electronic file generation request to the master node, wherein the master node and each of the at least one member node, each as independent block respectively, are connected to each other; generating a security electronic file by the master node based on the received security electronic file generation request, and transmitting the generated security electronic file to the member node specified by the security electronic file generation request; and performing operations on the security electronic file by any of the at least one member node after receiving the security electronic file by performing data communication with another member node. The system and method disclosed by the invention has high data file processing efficiency and low cost.

### FIELD OF THE INVENTION

The present disclosure relates to an electronic file processing system and method, and in particular to a security electronic file processing system and method based on a block chain structure.

### BACKGROUND OF THE INVENTION

At present, with the increasing popularity of network-based applications and the increasing growth of the variety of services in different fields (such as the financial field), efficient processing of specific data files, such as ticket files in the financial field, is becoming more and more important.

In the prior art solutions, the processing of the specific data file is typically implemented in the following manner: the paper target data files or electronized target data files are centralized at a central data processing server, and then the central data processing server processes the target data files manually or automatically.

However, the above prior art solutions have the following problems: since the centralized processing mode is adopted, the efficiency is low and the load distribution is unbalanced; in addition, since the paper carrier is required, the cost is high.

Therefore, there is a need to provide a security electronic file processing system and method based on a block chain structure with high data file processing efficiency and low cost.

### SUMMARY OF THE INVENTION

In order to solve the problems existing in the above prior art solutions, the present disclosure proposes a security electronic file processing system and method based on a block chain structure with high data file processing efficiency and low cost.

The object of the present disclosure is achieved by the following technical solutions:

A security electronic file processing system is provided, which includes a master node and at least one member node, wherein the master node and each of the at least one member node, each as independent block respectively, are connected to each other to form a block chain;

the master node is configured to generate a security electronic file based on a security electronic file generation request from any member node, and transmit the generated security electronic file to a member node specified by the security electronic file generation request;

each of the at least one member node is capable of constructing the security electronic file generation request based on an occurrence of a trigger event, and transmitting the security electronic file generation request to the master node; and

the at least one member node is further capable of receiving a security electronic file from the master node, and is capable of performing operations on the security electronic file through data communication with another member node.

In the solution disclosed above, preferably, only the master node is capable of generating the security electronic file.

In the solution disclosed above, preferably, the security electronic file is transmitted in an encrypted manner between relevant nodes of the block chain.

In the solution disclosed above, preferably, each of the at least one member node can be associated with a business entity and/or an individual, i.e., the business entity and/or the individual are accesible to the block chain via one or more of the at least one member node.

In the solution disclosed above, preferably, after the business entity being connected into the block chain via one or more of the at least one member node, the business entity can construct and send the security electronic file generation request via the member node(s).

In the solution disclosed above, preferably, after the individual being connected into the block chain via one or more of the at least one member node, the individual can receive the security electronic file via the member node(s), and can perform operations on the security electronic file through data communication with the member node(s) accessed by the business entity.

In the solution disclosed above, preferably, the business entity is capable of querying and browsing the security electronic file associated therewith via the member node.

In the solution disclosed above, preferably, the individual is capable of querying and browsing the security electronic file associated therewith via the member node.

In the solution disclosed above, preferably, before performing operations on the security electronic file, the member node accessed by the business entity is capable of verifying the validity of the security electronic file, and the operations on the security electronic file are actually performed only after the verification is passed.

In the solution disclosed above, preferably, the operations on the security electronic file include transferring ownership of the security electronic file and performing a resource transfer operation associated with the security electronic file.

The object of the present disclosure can also be achieved by the following technical solutions:

A security electronic file processing method based on a block chain structure is provided, which includes the following steps:

(A1) constructing a security electronic file generation request based on an occurrence of a trigger event by a member node in a block chain formed by a master node and at least one member node, and transmitting the security electronic file generation request to the master node, wherein the master node and each of the at least one member node, each as independent block respectively, are connected to each other;

(A2) generating a security electronic file by the master node based on the received security electronic file generation request, and transmitting the generated security electronic file to the member node specified by the security electronic file generation request; and

(A3) performing operations on the security electronic file by any of the at least one member node after receiving the security electronic file by performing data communication with another member node.

In the solution disclosed above, preferably, only the master node is capable of generating the security electronic file.

In the solution disclosed above, preferably, the security electronic file is transmitted in an encrypted manner between relevant nodes of the block chain.

In the solution disclosed above, preferably, each of the at least one member node can be associated with a business entity and/or an individual, i.e., the business entity and/or the individual are accessible to the block chain via one or more of the at least one member node.

In the solution disclosed above, preferably, after the business entity being connected into the block chain or having access to the block chain via one or more of the at least one member node, the business entity can construct and send the security electronic file generation request via the member node(s).

In the solution disclosed above, preferably, after the individual being connected into the block chain or having access to the block chain via one or more of the at least one member node, the individual can receive the security electronic file via the member node(s), and can perform operations on the security electronic file through data communication with the member node(s) accessed by the business entity.

In the solution disclosed above, preferably, the business entity is capable of querying and browsing the security electronic file associated therewith via the member node.

In the solution disclosed above, preferably, the individual is capable of querying and browsing the security electronic file associated therewith via the member node.

In the solution disclosed above, preferably, before performing operations on the security electronic file, the member node accessed by the business entity is capable of verifying the validity of the security electronic file, and the operations on the security electronic file are actually performed only after the verification is passed.

In the solution disclosed above, preferably, the operations on the security electronic file include transferring ownership of the security electronic file and performing a resource transfer operation associated with the security electronic file.

The security electronic file processing system and method based on a block chain structure disclosed by the present disclosure have the following advantages: since the master node 1 is only used to generate a security electronic file, and other operations on the security electronic file are performed by other nodes in the block chain, the data processing efficiency is high, and the cost is low due to the use of electronic file.

### BRIEF DESCRIPTION OF THE DRAWINGS

The technical features and advantages of the present disclosure will be better understood by those skilled in the art with reference to the accompanying drawings, in which:

FIG. 1 is a schematic structural diagram of a security electronic file processing system based on a block chain structure according to an embodiment of the present disclosure;

FIG. 2 is a flow chart of a security electronic file processing method based on a block chain structure according to an embodiment of the present disclosure.

### DETAILED DESCRIPTION OF THE EMBODIMENT(S) OF THE INVENTION

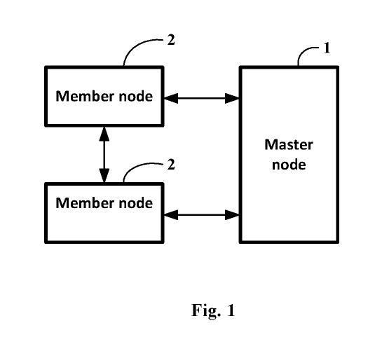

FIG. 1 is a schematic structural diagram of a security electronic file processing system based on a block chain structure according to an embodiment of the present disclosure. As shown in FIG. 1, the security electronic file processing system disclosed by the present disclosure includes a master node 1 and at least one member node 2, wherein the master node 1 and each of the at least one member node 2, each as independent block respectively, are connected to each other to form a block chain. The master node 1 (e.g., a tax authority node) generates a security electronic file (e.g., a ticket in the financial field, such as an electronic invoice) based on a security electronic file generation request from any member node 2, and transmits the generated electronic file to the member node 2 specified by the security electronic file generation request. Each of the at least one member node 2 is capable of constructing the security electronic file generation request based on an occurrence of a trigger event (e.g., a consumption event), and transmitting the security electronic file generation request to the master node 1. The at least one member node 2 is further capable of receiving a security electronic file from the master node 1, and is capable of performing operations on the security electronic file (e.g., reimbursement of electronic invoice) through data communication with another member node 2.

Preferably, in the security electronic file processing system disclosed by the present disclosure, only the master node 1 is capable of generating the security electronic file.

Preferably, in the security electronic file processing system disclosed by the present disclosure, the security electronic file is transmitted in an encrypted manner between relevant nodes of the block chain.

Preferably, in the security electronic file processing system disclosed by the present disclosure, each of the at least one member node 2 can be associated with a business entity (e.g., enterprise) and/or an individual, i.e., the business entity (e.g., enterprise or merchant) and/or the individual are accessible to the block chain via one or more of the at least one member node 2.

Preferably, in the security electronic file processing system disclosed by the present disclosure, after the business entity (e.g., enterprise or merchant) being connected into the block chain or having access to the block chain via one or more of the at least one member node 2, the business entity can construct and send the security electronic file generation request via the member node 2.

Preferably, in the security electronic file processing system disclosed by the present disclosure, after the individual being connected into the block chain or having access to the block chain via one or more of the at least one member node 2, the individual can receive the security electronic file via the member node 2, and can perform operations on the security electronic file (e.g., reimbursement of electronic invoice) through data communication with the member node 2 accessed by the business entity.

Preferably, in the security electronic file processing system disclosed by the present disclosure, the business entity is capable of querying and browsing the security electronic file associated therewith via the member node 2.

Preferably, in the security electronic file processing system disclosed by the present disclosure, the individual is capable of querying and browsing the security electronic file associated therewith via the member node 2.

Preferably, in the security electronic file processing system disclosed by the present disclosure, before performing operations on the security electronic file, the member node 2 accessed by the business entity is capable of verifying the validity of the security electronic file, and the operations on the security electronic file are actually performed only after the verification is passed.

Preferably, in the security electronic file processing system disclosed by the present disclosure, the operations on the security electronic file include transferring ownership of the security electronic file and performing a resource transfer operation associated with the security electronic file (e.g., fund transfer operation).

It can be seen from the above that the security electronic file processing system disclosed by the present disclosure has the following advantages: since the master node 1 is only used to generate a security electronic file, and other operations on the security electronic file are performed by other nodes in the block chain, the data processing efficiency is high, and the cost is low due to the use of electronic file.

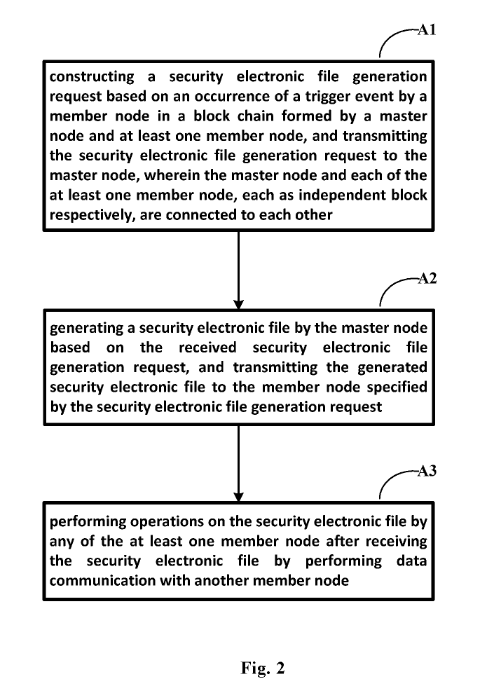

FIG. 2 is a flow chart of a security electronic file processing method based on a block chain structure according to an embodiment of the present disclosure. As shown in FIG. 2, the security electronic file processing method based on a block chain structure disclosed by the present disclosure includes the following steps: (A1) constructing a security electronic file generation request based on an occurrence of a trigger event (e.g., a consumption event) by a member node in a block chain formed by a master node and at least one member node, and transmitting the security electronic file generation request to the master node, wherein the master node and each of the at least one member node, each as independent block respectively, are connected to each other; (A2) generating a security electronic file (e.g., a ticket in the financial field, such as an electronic invoice) by the master node (e.g., a tax authority node) based on the received security electronic file generation request, and transmitting the generated security electronic file to the member node specified by the security electronic file generation request; and (A3) performing operations on the security electronic file (e.g., reimbursement of electronic invoice) by any of the at least one member node after receiving the security electronic file by performing data communication with another member node.

Preferably, in the security electronic file processing method disclosed by the present disclosure, only the master node is capable of generating the security electronic file.

Preferably, in the security electronic file processing method disclosed by the present disclosure, the security electronic file is transmitted in an encrypted manner between relevant nodes of the block chain.

Preferably, in the security electronic file processing method disclosed by the present disclosure, each of the at least one member node can be associated with a business entity (e.g., enterprise) and/or an individual, i.e., the business entity (e.g., enterprise or merchant) and/or the individual are accessible to the block chain via one or more of the at least one member node.

Preferably, in the security electronic file processing method disclosed by the present disclosure, after the business entity (e.g., enterprise or merchant) being connected into the block chain or having access to the block chain via one or more of the at least one member node, the business entity can construct and send the security electronic file generation request via the member node.

Preferably, in the security electronic file processing method disclosed by the present disclosure, after the individual being connected into the block chain or having access to the block chain via one or more of the at least one member node, the individual can receive the security electronic file via the member node, and can perform operations on the security electronic file (e.g., reimbursement of electronic invoice) through data communication with the member node accessed by the business entity.

Preferably, in the security electronic file processing method disclosed by the present disclosure, the business entity is capable of querying and browsing the security electronic file associated therewith via the member node.

Preferably, in the security electronic file processing method disclosed by the present disclosure, the individual is capable of querying and browsing the security electronic file associated therewith via the member node.

Preferably, in the security electronic file processing method disclosed by the present disclosure, before performing operations on the security electronic file, the member node accessed by the business entity is capable of verifying the validity of the security electronic file, and the operations on the security electronic file are actually performed only after the verification is passed.

Preferably, in the security electronic file processing method disclosed by the present disclosure, the operations on the security electronic file include transferring ownership of the security electronic file and performing a resource transfer operation associated with the security electronic file (e.g., fund transfer operation).

It can be seen from the above that the security electronic file processing method disclosed by the present disclosure has the following advantages: since the master node is only used to generate a security electronic file, and other operations on the security electronic file are performed by other nodes in the block chain, the data processing efficiency is high, and the cost is low due to the use of electronic file.

Although the present disclosure has been described through the preferred embodiments described above, the implementation forms thereof are not limited to the embodiments described above. It will be appreciated that those skilled in the art can make various changes and modifications to the present disclosure without departing from the spirit and scope of the present disclosure.

What is claimed is:

1. A security electronic file processing system, comprising a master node and at least one member node, wherein the master node and each of the at least one member node, each as independent block respectively, are connected to each other to form a block chain;
the master node is configured to generate a security electronic file based on a security electronic file generation request from any member node, and transmit the generated security electronic file to a member node specified by the security electronic file generation request;
each of the at least one member node is capable of constructing the security electronic file generation request based on an occurrence of a trigger event, and transmitting the security electronic file generation request to the master node; and
the at least one member node is further capable of receiving a security electronic file from the master node, and is capable of performing operations on the security electronic file through data communication with another member node.

2. The security electronic file processing system according to claim 1, wherein only the master node is capable of generating the security electronic file.

3. The security electronic file processing system according to claim 2, wherein the security electronic file is transmitted in an encrypted manner between relevant nodes of the block chain.

4. The security electronic file processing system according to claim 3, wherein each of the at least one member node can be associated with a business entity and/or an individual, i.e., the business entity and/or the individual are accessible to the block chain via one or more of the at least one member node.

5. The security electronic file processing system according to claim 4, wherein after the business entity being connected into the block chain via one or more of the at least one member node, the business entity can construct and send the security electronic file generation request via the member node(s).

6. The security electronic file processing system according to claim 5, wherein after the individual being connected into the block chain via one or more of the at least one member node, the individual can receive the security electronic file via the member node(s), and can perform operations on the security electronic file through data communication with the member node(s) accessed by the business entity.

7. The security electronic file processing system according to claim 6, wherein the business entity is capable of querying and browsing the security electronic file associated therewith via the member node.

8. The security electronic file processing system according to claim 7, wherein the individual is capable of querying and browsing the security electronic file associated therewith via the member node.

9. The security electronic file processing system according to claim 8, wherein before performing operations on the security electronic file, the member node accessed by the business entity is capable of verifying the validity of the security electronic file, and the operations on the security electronic file are actually performed only after the verification is passed.

10. The security electronic file processing system according to claim 9, wherein the operations on the security electronic file comprise transferring ownership of the security electronic file and performing a resource transfer operation associated with the security electronic file.

11. A security electronic file processing method based on a block chain structure, comprising the following steps:
(A1) constructing a security electronic file generation request based on an occurrence of a trigger event by a member node in a block chain formed by a master node and at least one member node, and transmitting the security electronic file generation request to the master node, wherein the master node and each of the at least one member node, each as independent block respectively, are connected to each other;
(A2) generating a security electronic file by the master node based on the received security electronic file generation request, and transmitting the generated security electronic file to the member node specified by the security electronic file generation request; and
(A3) performing operations on the security electronic file by any of the at least one member node after receiving the security electronic file by performing data communication with another member node.

12. The security electronic file processing method according to claim 11, wherein only the master node is capable of generating the security electronic file.

13. The security electronic file processing method according to claim 12, wherein the security electronic file is transmitted in an encrypted manner between relevant nodes of the block chain.

14. The security electronic file processing method according to claim 13, wherein each of the at least one member node can be associated with a business entity and/or an individual, i.e., the business entity and/or the individual are accessible to the block chain via one or more of the at least one member node.

15. The security electronic file processing method according to claim 14, wherein after the business entity being connected into the block chain via one or more of the at least one member node, the business entity can construct and send the security electronic file generation request via the member node(s).

16. The security electronic file processing method according to claim 15, wherein after the individual being connected into the block chain via one or more of the at least one member node, the individual can receive the security electronic file via the member node(s), and can perform operations on the security electronic file through data communication with the member node(s) accessed by the business entity.

17. The security electronic file processing method according to claim 16, wherein the business entity is capable of querying and browsing the security electronic file associated therewith via the member node.

18. The security electronic file processing method according to claim 17, wherein the individual is capable of querying and browsing the security electronic file associated therewith via the member node.

19. The security electronic file processing method according to claim 18, wherein before performing operations on the security electronic file, the member node accessed by the business entity is capable of verifying the validity of the security electronic file, and the operations on the security electronic file are actually performed only after the verification is passed.

20. The security electronic file processing method according to claim 19, wherein the operations on the security electronic file comprise transferring ownership of the security electronic file and performing a resource transfer operation associated with the security electronic file.
